(19) United States
(12) Patent Application Publication
(10) Pub. No.: US 2008/0185326 A1
(43) Pub. Date: Aug. 7, 2008

(54) Open-end filter assembly for fluid processing system

(76) Inventors: Mark Serafin, Apple Valley, MN (US); Stanley R. Ellis, Mahtomedi, MN (US); Neal K. Nelson, Stillwater, MN (US); Richard D. Olmsted, Vadnais Heights, MN (US)

Correspondence Address: Attention: Eric D. Levinson;Imation Corp., Legal Affairs, P.O. Box 64898, St. Paul, MN, 55164-0898, US

(21) Appl. No.: 11/703,476

(22) Filed: Feb. 7, 2007

(51) Int. Cl. B01D 35/02; B01D 35/22

(52) U.S. Cl. 210/186; 210/304; 210/512.1; 210/422; 210/232; 210/416.1

(57) ABSTRACT

The disclosure is directed to a fluid processing system utilizing an open-end filter assembly to produce a product fluid. The system includes a fluid pump to deliver the raw fluid to a fluid processor and a heat exchanger to control the temperature of the processed fluid. The processed fluid is sent to an open-end filter assembly that allows a first portion of the processed fluid to pass through a filter element. A second portion of the processed fluid does not pass through the filter element and is directed back to the high pressure pump for further processing. In one example, the open-end filter assembly includes an outer cylinder that surrounds a cylindrical filter element to create an outer flow channel and an inner flow channel. Fluid may be introduced to the outer flow channel in a tangential orientation to enhance circular flow around the filter element.

### TECHNICAL FIELD

The disclosure relates to fluid processing and, more particularly, fluid classification and filtering devices.

### BACKGROUND

The creation and processing of fluids in a fluid mixture is desirable for a variety of industrial processes. For example, fluids may be mixed, reacted or otherwise combined to form emulsions, suspensions or solutions. As an example, fluids may be mixed to form coatings, inks, paints, abrasive coatings, fertilizers, pharmaceuticals, biological products, agricultural products, foods, beverages, thickening agents, and the like. For some of these products, such as colloidal dispersions, the size and uniformity of dispersed phases can be extremely important.

To produce dispersions in a desired size range, industrial dispersion processing techniques make use of one or more fluid processing devices. A fluid processing device processes the fluid mixture in a manner that subjects dispersed phases, such as particles or other units of microstructure, to intense energy dissipation through a combination of intense shear and extensional forces. In this manner, a smaller, more uniformly sized dispersed phase is created in the colloidal dispersion.

However, dispersed phases created by the processing of fluid mixtures may not always generate desired sized dispersed phases or uniformity from a single fluid processing cycle. Some elements of the dispersed phase may be of a size that is not desired for the intended application of the dispersed phase. A filter may be used to remove unwanted sized elements of the dispersed phase such that only intended elements of the dispersed phase passes with the fluid to be used for other applications.

One example of a dispersion is a magnetic dispersion used in the coating of magnetic media, such as magnetic disks, magnetic tape or other magnetic media used for data storage. For magnetic media, the mixture may contain magnetic particles and a polymeric binder carried in a solvent. A magnetic coating process involves application of the mixture to a substrate, followed by a drying process to remove the solvent. To ensure data storage reliability, uniformity of the magnetic particles within the dispersion may be desirable.

### SUMMARY

The disclosure is directed to a fluid processing system that utilizes an open-end filter assembly to produce a product fluid. The system includes a fluid pump to deliver the raw fluid to a fluid processor and a heat exchanger to control the temperature of the processed fluid. In some examples, the heat exchanger may be incorporated with the fluid processor. The processed fluid is sent to an open-end filter assembly that allows a first portion of the processed fluid to pass through a filter element for use in various applications. A second portion of the processed fluid does not pass through the filter element and is directed back to the high pressure pump for further processing. In this manner, the fluid processing system may reduce particulate waste while increasing filtering efficiency and open-end filter assembly life.

In one example, the open-end filter assembly includes an outer cylinder that surrounds a cylindrical filter element to define an outer flow channel and an inner flow channel. The processed fluid flows through the outer flow channel under pressure to create a pressure gradient between the outer flow channel and the inner flow channel. The pressure gradient causes a portion of the fluid, which includes dispersed phases, to pass through the filter element and into the inner flow channel. The passed dispersed phases may be used as a product fluid for an intended application. Dispersed phases of the fluid that do not pass into the inner flow channel are directed out of the bypass outlet and back to the system to be reprocessed. In some examples, fluid may be introduced to the outer flow channel by one or more tangentially orientated inlet channels to enhance a circular flow around the filter element. The circular flow may reduce particulate build-up on the filter element while bringing more of the fluid in contact with the filter element.

In one embodiment, the invention provides an open-end filter assembly that includes an inlet, a bypass outlet, an outer flow channel coupled to the inlet and the bypass outlet, an inner flow channel in fluid communication with the outer flow channel via the filter element, and a filtered outlet coupled to the inner flow channel.

In another embodiment, the invention provides a system that includes a fluid pump, a fluid processor that processes raw fluid from the fluid pump, and an open-end filter assembly that allows a first portion of the fluid to pass through a filter element of the open-end filter assembly and directs a second portion of the fluid to the fluid pump.

In an additional embodiment, the invention provides a method including pumping a fluid to a fluid processor with a fluid pump, processing the fluid with the fluid processor, directing the fluid into an inlet of an open-end filter assembly, and directing the fluid through an outer flow channel coupled to the inlet of the open-end filter assembly and a bypass outlet of the open-end filter assembly. The method also includes passing a first portion of the fluid through a filter element of the open-end filter assembly, directing the first portion of the fluid through a filtered outlet of the open-end filter assembly, and directing a second portion of the fluid through the bypass outlet of the open-end filter assembly and to the fluid pump.

The invention, in various embodiments, may be capable of providing a number of advantages. In general, the disclosure may improve industrial manufacturing of coatings, inks, paints, abrasive coatings, fertilizers, foods, beverages, pharmaceuticals, biological products, agricultural products, thickening agents, or a wide variety of other media. The use of an open-end filter assembly may reduce waste product by reprocessing unfiltered particulates. More constant pressure may also be possible with the bypass outlet of the open-end filter assembly instead of forcing all dispersed phases through a closed-end filter assembly.

A fluid processing system utilizing open-end filter assemblies, as described herein, may allow the system to support high pressures, such as approximately 40,000 psi (275 MPa). Fluid pressures within the open-end filter assembly may be controlled to prevent rupturing of filter elements or forcing larger than desired particulates through the filter element. Further, multiple open-end filter assemblies may be staged in series to classify particulate sizes or other characteristics such that the product fluid may include uniformly shaped and sized particulates.

In addition, the filter assemblies described herein may provide circulation within the outer flow channel around the outside of the filter element to improve the function of the filter element within the open-end filter assembly. For example, circulation generated by tangentially oriented channels as inlets to the outer flow channel may reduce build-up of particulates at the outer surface of the filter element. This may increase the useful life of the filter element while exposing more of the fluid and particulates to the filter element to promote migration of allowable dispersed phases through the filter element.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram of an exemplary fluid processing system utilizing a single fluid processor and a single open-end filter assembly.

FIG. 2 is a flow diagram of an example method for operating the fluid processing system of FIG. 1.

FIG. 3 is a block diagram of an exemplary fluid processing system utilizing multiple fluid processors and a single open-end filter assembly.

FIG. 4 is a flow diagram of an example method for operating the fluid processing system of FIG. 3.

FIG. 5 is a block diagram of an exemplary fluid processing system utilizing multiple fluid processors and multiple open-end filter assemblies in series.

FIG. 6 is a flow diagram of an example method for operating the fluid processing system of FIG. 5.

FIG. 7 is a perspective view of an open-end filter assembly including a filter head and an outer cylinder showing input and output directions.

FIG. 8 is a cross-sectional side view of the open-end filter assembly of FIG. 7.

FIG. 9 is a cross-sectional axial view of the open-end filter assembly of FIG. 7.

FIG. 10 is a perspective view of an open-end filter assembly that inputs the fluid through tangential channels oriented tangentially to the outer flow channel of the filter assembly.

FIG. 11 is a cross-sectional side view of the open-end filter assembly of FIG. 10.

FIG. 12 is a cross-sectional axial view of the open-end filter assembly of FIG. 10 illustrating circular flow within the outer flow channel.

### DETAILED DESCRIPTION

The disclosure is directed to a fluid processing system that utilizes an open-end filter assembly to produce a product fluid. The system includes a vessel to hold raw fluid to be processed, a fluid pump to deliver the raw fluid to a fluid processor, and a heat exchanger to control the temperature of the processed fluid. The processed fluid is sent to an open-end filter assembly that allows a first portion of the processed fluid to pass through a filter element for use in various applications. A second portion of the processed fluid does not pass through the filter element and is directed back to the high pressure pump for further processing. A back pressure regulator may be used to regulate the back pressure of the second portion of fluid from the open-end filter assembly.

In one example, the open-end filter assembly includes an outer cylinder that surrounds a cylindrical filter element to create an outer flow channel and an inner flow channel. Fluid enters the outer flow channel through an inlet. Once in the outer flow channel, the fluid is able to be filtered. Specifically, dispersed phases small enough to pass through the filter element pass through the filter element and into the inner flow channel before leaving the filtered outlet of the open-end filter assembly. Dispersed phases that cannot pass through the filter element leave the outer flow channel by leaving the bypass outlet and flowing back into the system to be further processed. In addition, the open-end filter assembly may be modified to alter the operation of the filter assembly. Fluid may be introduced to the outer flow channel in a tangential orientation to produce a circular flow around the filter element. The circular flow around the filter element may reduce the dispersed phases from clinging to the filter element and increase the useful life of the filter element in the system. In this manner, the open-end filter assembly may be described as a surround-flow filter or circular-flow filter.

In general, a dispersed phase may include dispersed particles, colloidal dispersions, or other matter separated by a phase boundary. The fluid processing system mixes, reacts or otherwise combines two or more fluids to produce a combined product of the fluids before filtering the product fluid to separate the dispersed phase according to sizes within the dispersed phase.

For example, the fluid processing system may be useful in reducing the size of dispersed particles or other units of microstructure in one or more fluid mixtures, combining the fluids to form dispersions, such as emulsions or suspensions, and filtering the combined fluids according to the desired product. In addition, the fluid processing system may be applicable to a combination of fluids that do not carry particulate structures, including the mixture of fluids to form solutions. The open-end filter assembly may be used to filter any fine particulates within the fluids. As examples, the fluid processing system may be used for preparation of coatings, inks, paints, abrasive coatings, fertilizers, foods, beverages, pharmaceuticals, biological products, agricultural products, thickening agents, or a wide variety of other media.

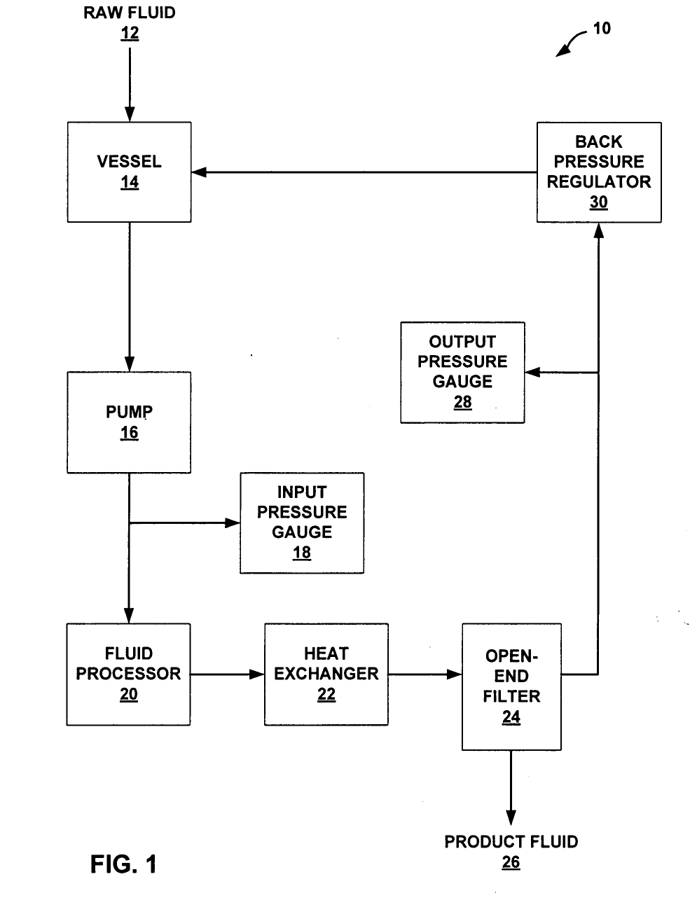

FIG. 1 is a block diagram of an exemplary fluid processing system 10 utilizing a single fluid processor and a single open-end filter assembly. As shown in FIG. 1, fluid processing system 10 includes vessel 14, pump 16, fluid processor 20, heat exchanger 22, open-end filter assembly 24, and back pressure regulator 30. Each element of fluid processing system 10 may be connected by one or more fluid conductors, e.g., conduits, pipes, or tubes, to transfer the fluid from the previous element of the system to the next successive element of the system. Fluid processing system 10 may also include input pressure gauge 18 to measure pressure of fluid from pump 16 and output pressure gauge 28 to measure the pressure of the fluid not filtered from open-end filter assembly 24.

Fluid processing system 10, with open-end filter assembly 24, may be particularly useful in processing coating solutions having high concentrations of solids. For example, fluid processing system 10 may be used to process and filter coating solutions having solid particle contents of greater than approximately ten percent by weight, although the system is not limited in that respect. For some industrial applications, a solution may carry hard, substantially non-compliant particles, such as magnetic pigments used for coating of magnetic media. Fluid processing system 10 may also be used for other industrial processes including, for example, the preparation of inks, paints, abrasive coatings, fertilizers, foods, beverages, pharmaceuticals, biological products, agricultural products, thickening agents, and a wide variety of other media. In some embodiments, fluid processing system 10 may be implemented to produce fluids with small particulates of consistent size, such as magnetic pigment particles. More generally, fluid processing system 10 may be implemented to mix, react or combine one or more fluids having different compositions to produce a combined product fluid 26 for use in an intended application.

Fluid processing system 10 processes raw fluid 12 in order to produce the filtered product fluid 26. In addition to processing raw fluid 12, fluid processing system 10 re-processes a portion of processed fluid that does not pass through open-end filter assembly 24. In other words, a portion of the processed fluid bypasses the filter element of open-end filter assembly 24 and is re-circulated within fluid processing system 10 while another portion passes through the filter element of open-end filter assembly 24 and out of the system as product fluid 26. Product fluid 26 may include dispersed phases small enough to pass through open-end filter assembly 24 with the pressure created by pump 16 and back pressure regulator 30. The re-circulated portion of fluid that is re-circulated is re-processed by fluid processor 20 in order to further reduce the size of dispersed phases to pass through the filter element of open-end filter 24.

Raw fluid 12 may be any fluid that may contain dispersed phases that are to be processed before the raw fluid can be used in an intended application. Raw fluid 12 is provided to vessel 14 where the raw fluid is stored until fluid processing system 10 is ready to intake the raw fluid. Vessel 14 may be any type of container for holding a fluid that is in fluid communication with pump 16. Vessel 14 may also include mixers to mix raw fluid 12 before being delivered by pump 16. Example mixers may include a planetary mixer, a double planetary mixer, or the like. In some examples, vessel 14 may not include a mixer or mixing mechanism. For example, in some cases, raw fluid 12 may be premixed or not require mixing. In other examples, vessel 14 may include multiple vessels that deliver raw fluid 12 to pump 16.

Pump 16 draws fluid from vessel 14 and generates pressure to the fluid that drives the movement of fluid through fluid processor 20 and open-end filter assembly 24 in order to produce product fluid 26. Pump 16 may comprise an intensifier pump or high-pressure pump that increases the pressure of the fluid and forces the fluid through fluid processor 20, heat exchanger 22, and open-end filter assembly 24. Pump 16 may be capable of generating approximately 100 to 40,000 psi (690 kPa to 275 MPa) of fluid pressure. Fluid processor 20, as described herein, may be capable of handling pressures greater than approximately 10,000 psi (68,950 kPa), greater than approximately 30,000 psi (207 MPa), or greater than approximately 40,000 psi (275 MPa). In some examples, multiple pumps 16 may be used to pressurize the fluid before fluid processor 20 instead of or in addition to one or more pumps located after the fluid processor.

Pressure of the fluid from pump 16 may be monitored by input pressure gauge 18. Input pressure gauge 18 may detect the pressure of passing fluid from pump 16 before entering fluid processor 20. Input pressure gauge 18 may be mounted at the outlet of pump 16, at a point along the fluid path to fluid processor 20, or within fluid processor 20 before the fluid is processed. Input pressure gauge 18 may comprise any type of fluid pressure gauge including mechanical pressure gauges, pressure transducers, strain gauges, or optical sensors as examples. The pressure produced by pump 16 may be controlled with feedback directly from input pressure gauge 18 to automatically keep the pressure of the fluid within a desired range. In this manner, input pressure gauge 18 may be monitored locally or the gauge may be a transmitter which sends the pressure measurement to a system that incorporates the pressure measurement as feedback.

Raw fluid 12 is delivered to fluid processor 20 by the pressure from pump 16. Fluid processor 20 may be any type device that mixes, processes, reacts or otherwise changes raw fluid 12 in some manner into a processed fluid that may be used in a desired application. Dispersed phases of raw fluid 12 may be changed to be more uniform in size or reduced in size. Fluid processor 20 may use certain flow paths that utilize shear forces and/or collisions to break up particulates of the fluid, mix the fluid, cause chemical reactions to occur within the fluid. Alternatively, fluid processor 20 may include one or more moving parts that mix the fluid, cause separation particulates, or catalyze chemical reactions of the fluid. In any case, fluid processor 20 may be used to alter raw fluid 12 towards an intended fluid mixture or consistency.

In one example, fluid processor 20 makes use of opposing, coaxial, annular fluid flow channels for processing raw fluid 12. Fluid processor 20 may include a flow path cylinder and a rod positioned inside the flow path cylinder. Annular flow channels are defined by the outer diameter of the rod and the inner diameter of the flow path cylinder. Specifically, fluid in the two annular flow channels flow toward one another through the cylinder, and meet (or impinge) within the cylinder, such as near the center of the gap in the cylinder between the two annular flow channels. The opposing forces created by the collision of the fluids transmitted along the annular flow channels create shear and extensional forces. The fluid flows oppose one another within the cylinder. An outlet extends through the cylinder where the fluids flowing down the two annular flow channels collide, allowing the resulting combined and processed product to be expelled through the outlet. The shear and extensional forces during the collision of the fluids and elsewhere within the annular flow channels cause a reduction in size of the dispersed phase prior to expulsion through the gap, e.g., producing particles of reduced and more consistent size. Moreover, annular flow channels may enhance wall shear forces in fluid processor 20 by increasing surface area associated with a given flow channel. In other words, fluid processor 20 serves to reduce the size of the dispersed phase in the first and second fluids, producing smaller-sized particles, and thereby producing a finely dispersed solution of particles having a desired size range.

The rod may be cylindrical, and can be positioned within the flow path cylinder to define the inner diameter of the annular, coaxial flow channels. In other words, an inner diameter of the flow path cylinder defines an outer diameter of the annular flow channels, and an outer diameter of the cylindrical rod positioned inside the flow path cylinder defines an inner diameter of the annular flow channels. In some embodiments, the cylindrical rod may be free to move and vibrate within the flow path cylinder, which can provide an automatic anti-clogging action. In other embodiments, the cylindrical rod may be fixedly attached to a structure within fluid processor 20 to inhibit vibrations during fluid movement. Also, the outlet may be formed by an adjustable gap defined by two separate flow path cylinders positioned on a common axis in series, with the rod extending into both cylinders. In that case, the first and second fluids flow down the respective coaxial cylinders in opposing directions and meet at the adjustable gap defined by separation of the two separate flow path cylinders. In some examples, the opposing annular flow channels may have different annular areas if two different fluids are combined and processed by fluid processor 20.

For dispersions, the shear and/or extensional forces may cause the dispersed phase(s) in the fluids to be reduced in size, producing smaller particles, and also cause the fluids to mix, react or otherwise combine together prior to expulsion through the outlet. Fluid processor 20 may subject the fluids to wall shear forces at the beginning and throughout the annular flow channels, further promoting mixing or reaction and a more consistently sized dispersed phase. In some particular applications, one or both fluids may include a dispersion of magnetic particles, e.g., for coating of magnetic data storage media. However, the invention is not so limited.

Once raw fluid 12 is processed, it is referred to as processed fluid. The processed fluid is directed to heat exchanger 22 to regulate the temperature of the processed fluid. Heat exchanger 22 may be capable of operating in high pressure environments to either dissipate heat from the processed fluid or increase the thermal energy of the processed fluid. Heat exchanger 22 may have a conventional design. For example, a heat exchanger 22 may include a helical fluid carrying tube that passes through a heating or cooling medium, such as heated or cooled liquid or vapor. In some examples, heat exchanger 22 may be incorporated into fluid processor 20. In other examples, heat exchanger 22 may be placed between pump 16 and fluid processor 20. Alternatively, two heat exchangers 22 may be used with one on either side of fluid processor 20. Additional heat exchangers may be used within fluid processing system 10 at any location within the system.

After the processed fluid passes through heat exchanger 22, the processed fluid is directed to open-end filter assembly 24 to filter and classify the processed fluid. Open-end filter assembly 24 separates the processed fluid into two portions. The first portion is product fluid 26 to be removed, packaged, or used for any intended application. The second portion of the processed fluid is retained within fluid processing system 10 in order to re-circulate the second portion through the system and reprocesses the second portion with raw fluid 12 in order to create product fluid 26 from the second portion of the fluid. The second portion of the processed fluid may have dispersed phases that are not allowed to pass through the filter element (not shown) of open-end filter assembly 24.

Open-end filter assembly 24 may be used to filter particles from the dispersed phases of the processed fluid to separate product fluid 26 from the rest of the processed fluid. For example, open-end filter assembly 24 may comprise one or more porous filter elements, mesh screens, or the like, to filter the final combined product. Product fluid 26, which passes through the filter element of open-end filter assembly 24, may be then used, e.g., for coating, packaging or some other end application. In some cases, for example, the output may be packaged and sold, e.g., in the case of coatings, inks, paints, dyes, fertilizers, foods, beverages, pharmaceuticals, biological products, agricultural products, thickening agents, or a wide variety of other media.

In one example, open-end filter assembly 24 includes an outer cylinder that surrounds a cylindrical filter element to create an outer flow channel and an inner flow channel. Processed fluid enters the outer flow channel through an inlet from heat exchanger 22. Once in the outer flow channel, the processed fluid is filtered by a pressure difference from higher pressure in the outer flow channel and lower pressure in the inner flow channel. Specifically, dispersed phases, e.g., particulates, small enough to pass through the filter element of open-end filter assembly 24 pass through the filter element and into the inner flow channel before leaving the filtered outlet of the open-end filter assembly as product fluid 26. Particulates that cannot pass through the filter element of open-end filter assembly 24 leave the outer flow channel as the second portion of the fluid by leaving the bypass outlet and flowing back into the system to be further processed.

In other examples, open-end filter assembly 24 may be modified to alter the operation of the filter assembly. Fluid may be introduced to the outer flow channel in a tangential orientation to produce a circular flow around the filter element. The circular flow around the filter element may reduce the number of particulates of the processed fluid from clinging to the filter element, clogging the filter element, and preventing appropriate particulates through the filter element. This circulation within open-end filter assembly 24 may increase the useful life of the filter element in fluid processing system 10. In this manner, open-end filter assembly 24 may be described as a surround-flow filter or circular-flow filter.

The second portion of fluid that leaves open-end filter assembly 24 through the bypass outlet is directed to back pressure regulator 30. Output pressure gauge 28 may be similar to input pressure gauge 18, but output pressure gauge 28 may be configured for monitoring a lower pressure. Output pressure gauge 28 monitors the pressure of the second portion of the fluid such that back pressure regulator 30 can be changed to retain a desired pressure and regulate the pressure difference between pump 16 and the back pressure regulator. The difference between the pressures of input pressure gauge 18 and output pressure gauge 28 determines the driving pressure that processes raw fluid 12 and filters the processed fluid at open-end filter assembly 24. Output pressure gauge 28 may be monitored locally or the gauge may be a transmitter which sends the pressure measurement to a system that incorporates the pressure measurement as feedback. In alternative examples, an additional pump may be located downstream of fluid processor 20 or heat exchanger 22 in order to accurately control the pressure differential within open-end filter assembly 24.

The filter element of open-end filter assembly 24 may be a filter cartridge conventionally used within fluid processing systems currently used to separate dispersed phases. For example, the filter element may be constructed of a polymer film, a wound filament, a porous mesh, or any other type of filter element suited for filtering the size of particulates for product fluid 26. Alternatively, the filter element may filter the dispersed phases according to a property other than particulate size. For example, the filter element may allow particulates to pass according to their electrical charge, hydrophobic/hydrophilic characteristics, buoyancy, or any other property that can be used to separate particulates within the fluid. Open-end filter assembly 24 may be configured such that the filter element is removable from the open-end filter assembly. A new filter element may then be placed within open-end filter assembly 24 to continue filtering of the processed fluid.

In alternative examples, open-end filter assembly 24 may include a valve near a bypass outlet that may be closed to create a configuration that prevents the second portion of fluid from leaving the open-end filter assembly through the bypass outlet of the filter assembly. In this manner, open-end filter assembly 24 may be configured as a closed-end filter assembly which forces all fluid through the filter element. Conversely, back pressure regulator 30 may be utilized as the valve to increase pressure to force substantially all fluid through the filter element and create a closed-end filter.

Back pressure regulator 30 may be used to maintain substantially constant pressure within fluid processing system 10 and regulate the output flow rate of fluid back to vessel 14. In this manner, a desired ratio of the output flow rate of fluid back to vessel 14 and the flow rate of product fluid 26 may be controlled. A flow meter may also be used to monitor and provide feedback in a closed-loop system to control the flow rate via back pressure regulator 30. Back pressure regulator 30 may include one or more valves that open and close to appropriately restrict the flow of fluid back to vessel 14. Back pressure regulator 30 may be automatically controlled based upon the measurements of fluid pressure from output pressure gauge 28. In addition, a pressure gauge may also be used to monitor pressure of processed fluid before entering open-end filter assembly 24. While back pressure regulator 30 may be a stand-alone element within fluid processing system 10, some examples of the system may include back pressure regulator 30 as part of open-end filter assembly 24 or vessel 14. Since the second portion of processed fluid is sent back through fluid processing system 10, raw fluid 12 may be combined with the second portion of fluid when being processed. Therefore, raw fluid 12 in vessel 14, pump 16 and fluid processor 20 may include unprocessed raw fluid 12 and a portion of processed fluid not classified as product fluid 26.

In other examples, fluid processing system 10 may process two types of raw fluid that are each processed, mixed, or reacted at fluid processor 20. Fluid processor 20 may include two separate input channels to accept the two types of raw fluid that is combined into a single processed fluid. In this case, already processed fluid from open-end filter assembly 24 may be added to one of the two raw fluids to be re-processed by fluid processing system 10. In alternative examples, the processed fluid sent back to be re-processed may be further filtered, processed, or treated before being again combined with one or both of the raw fluids.

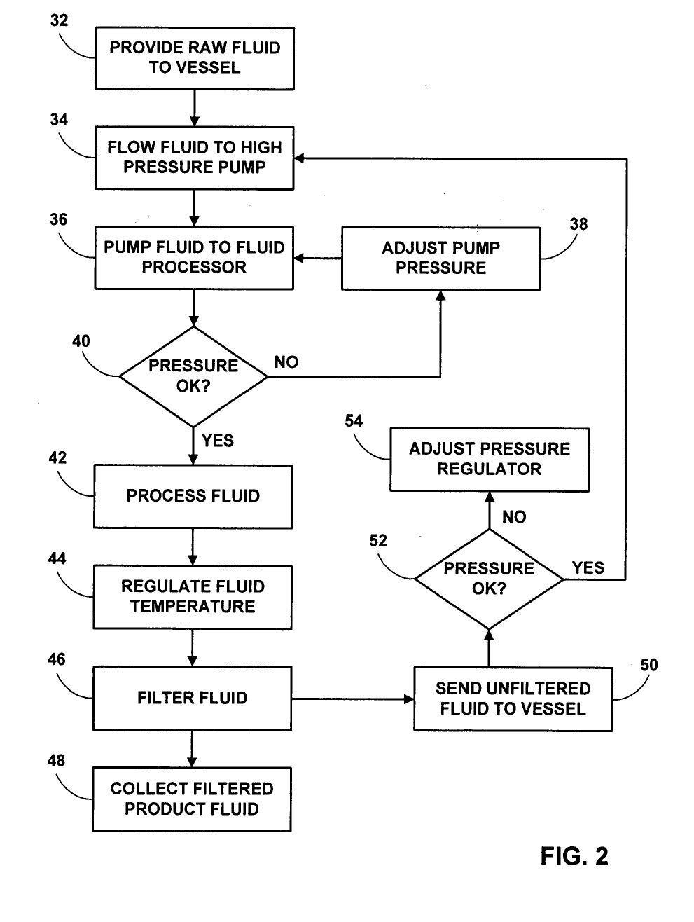

FIG. 2 is a flow diagram of an example method for operating fluid processing system 10 of FIG. 1. As shown in FIG. 2, raw fluid 12 is initially provided to vessel 14 by an automated delivery system or workers as fluid processing system 10 (32). From vessel 14, raw fluid 12 is directed to flow to pump 16 for pressurization (34). Pump 16 increases the pressure of raw fluid 12 and pumps the raw fluid to fluid processor 20 (36). Input pressure gauge monitors the pressure of raw fluid 12 to determine if the pressure of the fluid is within a desired range (40). If the pressure of raw fluid 12 is outside of a target range, pump 16 is adjusted to meet the range of fluid pressure (38). If the pressure is within the range, raw fluid 12 is directed to fluid processor 20 where it is processed (42).

After raw fluid 12 is processed by fluid processor 20 (42), heat exchanger 22 regulates the temperature of the processed fluid (44). Next, the processed fluid is directed to open-end filter assembly 24 where the processed fluid is filtered and separated into two portions (46). The filtered portion, or product fluid 26, is collected and used for an intended application (48). The unfiltered second portion of fluid is directed back to vessel 14 for reprocessing (50). If the pressure of the second portion of fluid is not within a target pressure range (52), back pressure regulator 30 is adjusted accordingly (54). Alternatively, back pressure regulator may regulate the output flow rate of the second portion of fluid. If the pressure of the second portion of fluid is acceptable (52), the fluid continues back to vessel 14 and is pressurized by pump 16 (34). The recirculation of the second portion of fluid from open-end filter assembly 24 allows fluid processing system 10 to maximize the amount of product fluid 26 while minimizing any waste particulates and fluid.

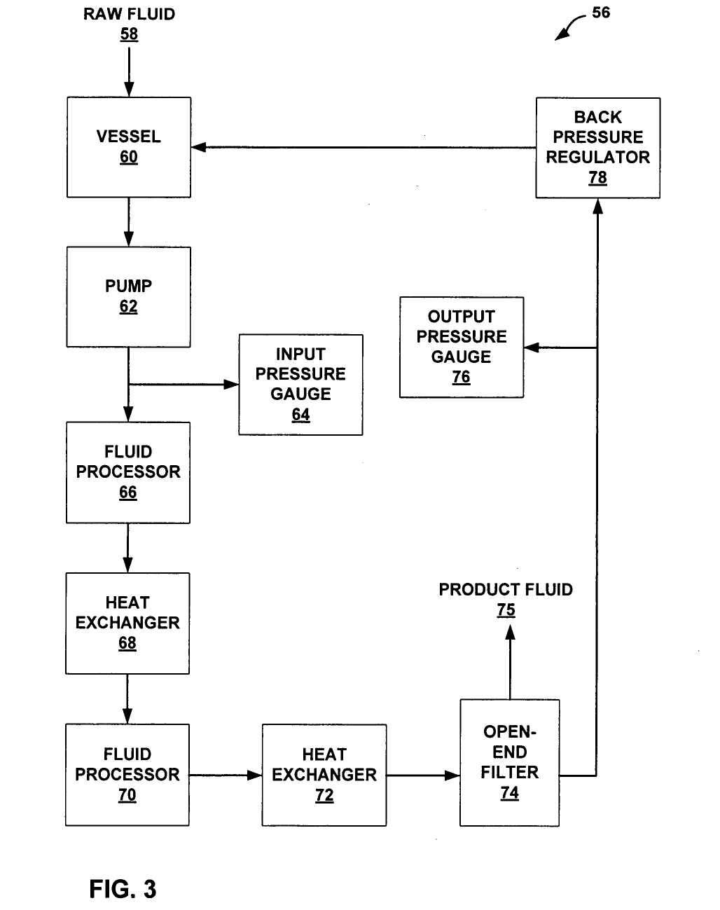

FIG. 3 is a block diagram of exemplary fluid processing system 56 utilizing multiple fluid processors 66 and 70 and a single open-end filter assembly 74. As shown in FIG. 3, fluid processing system 56 is very similar to fluid processing system 10 of FIG. 1. However, fluid processing system 56 utilizes two fluid processors 66 and 70 and two heat exchangers 68 and 72 in processing raw fluid 58. Fluid processing system 56 includes vessel 60, pump 62, input pressure gauge 64, fluid processors 66 and 70, heat exchangers 68 and 72, open-end filter assembly 74, output pressure gauge 76, and back pressure regulator 78. In some cases, flow meters may be also provided to monitor the flow rate of product fluid 75, the second portion of fluid that flows back to vessel 60, and/or the input flow rate of raw fluid 12. Flow meters may be used as feedback in a closed-loop system to adjust back pressure regulator 78. Fluid processing system 56 produces product fluid 75 from raw fluid 58. Product fluid 75 may include dispersed phases that are useful in a variety of applications. Pressure gauges 64 and 78 may be used to monitor pressure locally or as a transmitter that sends the pressure measurement to the system to be incorporated as feedback.

By using two fluid processors 66 and 70, fluid processing system 56 can reduce the size of particulates in and increase the mixing action of raw fluid 58 in only one circulation of the raw fluid through the system. In one example, fluid processors 66 and 70 are similar and provide additional shear forces and collisions in reducing particulates to uniform sizes. In other examples, fluid processors 66 and 70 provide different processing to raw fluid 58. Fluid processor 66 may be configured to accept particulates of larger sizes and reduce the particulates to sizes accepted by subsequent fluid processor 70. Fluid processor 70 can then further reduce the size of particulates within the fluid and further mixes the dispersed phases of the fluid. Alternatively, fluid processors 66 and 70 may be configured to perform different actions on raw fluid 58. For example, fluid processor 66 may cause chemical reactions to occur within raw fluid 58 that precipitate particulates or otherwise change the dispersed phases. Also, fluid processor 70 may provide shear stresses and collisions to reduce the size of the particulates and further mix the dispersed phases.

Heat exchangers 68 and 72 are utilized after each respective fluid processor 66 and 70 to manage the temperature of the fluid. Heat exchangers 68 and 72 may heat or cool the fluid due to changes in fluid temperature from high pressure from pump 62 and/or friction from fluid processors 66 and 70. Heat exchangers 68 and 72 may or may not include closed feedback from a temperature gauge to adjust each heat exchanger as necessary. After raw fluid 58 is processed by fluid processors 66 and 70 and heat exchangers 68 and 72, the processed fluid is separated by open-end filter assembly 74 into a first portion that is product fluid 75 and a second portion that is returned to fluid processing system 56 for reprocessing. Open-end filter assembly 74 may operate similarly to open-end filter assembly 24 of FIG. 1.

In alternative examples, open-end filter assembly 74 may include a valve near a bypass outlet that may be closed to prevent the second portion of fluid from leaving the open-end filter assembly. In this manner, open-end filter assembly 74 may be configured as a closed-end filter assembly which forces all fluid through the filter element. Conversely, back pressure regulator 78 may increase pressure to force substantially all fluid through the filter element and create a closed-end filter.

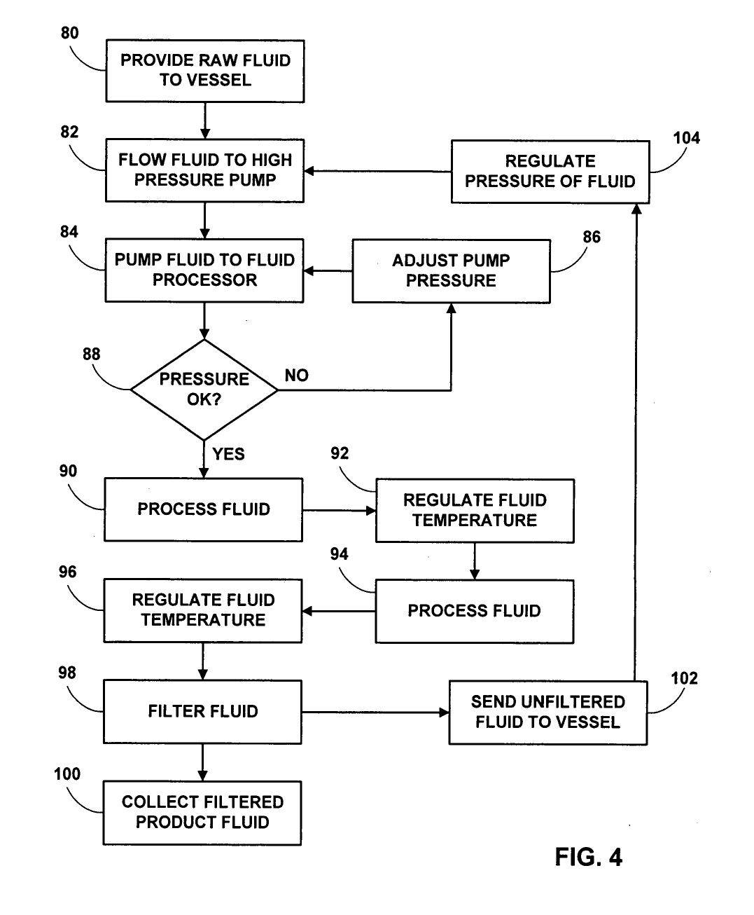

FIG. 4 is a flow diagram of an example method for operating fluid processing system 56 of FIG. 3. As shown in FIG. 4, raw fluid 58 is initially provided to vessel 60 by an automated delivery system or workers as fluid processing system 56 (80). From vessel 60, raw fluid 58 is directed to flow to pump 62 for pressurization (82). Pump 62 increases the pressure of raw fluid 58 and pumps the raw fluid to fluid processor 66 (84). Input pressure gauge 64 monitors the pressure of raw fluid 58 to determine if the pressure of the fluid is within a desired range (88). If the pressure of raw fluid 58 is outside of a target range, pump 62 is adjusted to meet the range of fluid pressure (86). If the pressure is within the range, raw fluid 58 is directed to fluid processor 62 where it is processed (90).

After raw fluid 58 is processed by fluid processor 66 (90), heat exchanger 68 regulates the temperature of the processed fluid (92). Then, fluid processor 70 further processes the fluid (94) before heat exchanger 72 regulates the temperature of the processed fluid (96). Next, the processed fluid is directed to open-end filter assembly 74 where the processed fluid is filtered and separated into two portions (98). The filtered portion, or product fluid 75, is collected and used for an intended application (100). The unfiltered second portion of fluid is directed back to vessel 60 for reprocessing (102). Output pressure gauge 76 monitors the pressure of re-circulated processed fluid and is used to adjust back pressure regulator 78 in regulating the pressure of the fluid leaving open-end filter assembly 74 (104). The recirculation of the second portion of fluid from open-end filter assembly 76 allows fluid processing system 56 to maximize the amount of product fluid 75 while minimizing any waste particulates and fluid.

In some examples, flow meters may be used to aid in the method of FIG. 4. A flow meter may monitor fluid flow of the second portion of fluid from open-end filter assembly 74 as feedback in a closed-loop system. In this manner, fluid processing system 56 may regulate flow of the second portion of fluid via the added flow meter and/or back pressure regulator 78. In addition, fluid processing system 56 may incorporate temperature sensors downstream of fluid processors 66 and 70 to monitor the temperature of the respective fluid. The method may utilize the temperature sensors in order to regulate heat exchangers 68 and 72 according to the sensed temperature of the fluid.

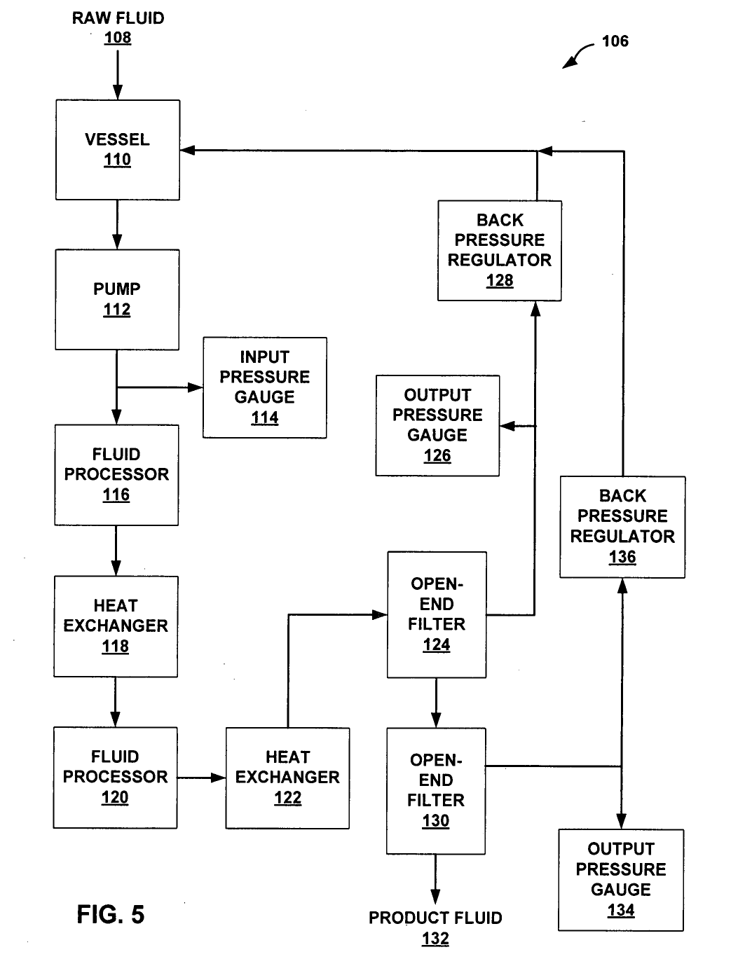

FIG. 5 is a block diagram of exemplary fluid processing system 106 utilizing multiple fluid processors 116 and 120 and multiple open-end filter assemblies 124 and 130 in series. As shown in FIG. 5, fluid processing system 106 is similar to fluid processing system 56 of FIG. 3. However, fluid processing system 106 includes two open-end filter assemblies 124 and 130 arranged in series. Raw fluid 108 is delivered to vessel 110 where the raw fluid is stored until advanced through fluid processing system 106. Pump 112 pressurizes raw fluid 108 such that the raw fluid is delivered to fluid processor 116 for processing. Input pressure gauge 114 monitors the pressure of raw fluid 108 and provides feedback to pump 112. The temperature of the fluid is then adjusted by heat exchanger 118 and delivered to fluid processor 120. Heat exchanger 122 is provided to again adjust the temperature of the processed fluid, as necessary. Pressure gauges 114, 126 and 134 may be used to monitor pressure locally or as a transmitter that sends the pressure measurement to the system to be incorporated as feedback.

After processing, the fluid is ready to be separated or filtered. Open-end filter assembly 124 is the first filter assembly of the series and allows filtered dispersed phases to pass along to open-end filter assembly 130. Particulates and fluid not allowed through the filter element of open-end filter assembly 124 is directed back to fluid processing system 106. Output pressure gauge 126 measures the pressure of the fluid from open-end filter assembly 124, which is controlled by back pressure regulator 128 before being sent back to vessel 110. Fluid passing through the filter element from open-end filter assembly 124 is directed to open-end filter assembly 130 for further filtering. Fluid and particulates that are allowed through the filter element of open-end filter assembly 130 make up product fluid 132. The second portion that does not pass through the filter element is sent back into fluid processing system 106. Output pressure gauge 134 monitors the pressure of the fluid while back pressure regulator 136 maintains a constant pressure of the fluid before directing the fluid back to vessel 110. In addition, back pressure regulators 128 and 136 may regulate fluid output flow rate as needed in fluid processing system 106.

In some examples, fluid processing system 106 may be used to process fluid and classify processed dispersed phases to collect only desired particulates. For example, open-end filter assembly 124 may have a filter element that has a larger-pore size than the filter element of open-end filter assembly 130. The larger pore size of the filter element of open-end filter assembly 124 may be less restrictive to fluid and particulates of dispersed phases than the filter element of open-end filter assembly 130 which has smaller pore sizes. Pore size refers to the holes, spaces or gaps within the filter element that allow solid particles to pass through the filter element.

In other words, open-end filter assembly 124 may allow particulates smaller than a certain size to pass on to open-end filter assembly 130. However, product fluid 132 may include the particulates too large to be passed by the filter element of open-end filter assembly 130. In this manner, filter assemblies 124 and 130 may produce a product fluid with particulates within a certain size range. Particulates which are small enough to pass though the filter element of open-end filter assembly 130 may be discarded or sent back to vessel 110 where some smaller particulates may combine to form larger particulates. In any case, two or more open-end filter assemblies may enable fluid processing system 106 to selectively determine the sizes of particulates in product fluid 132.

In alternative examples, one or both of open-end filter assemblies 124 and 130 may include a valve near a bypass outlet of the assembly that may be closed to prevent the second portion of fluid from leaving the open-end filter assembly. In this manner, open-end filter assemblies 124 and/or 130 may be configured as closed-end filter assemblies which force all fluid through the respective filter elements. Conversely, one or both of back pressure regulators 128 and 136 may act as the valve to increase pressure and force substantially all fluid through the filter element of the created closed-end filter.

In addition to pressure gauges 114, 126 and 134, fluid processing system 106 may also include pressure gauges that monitor input pressures of fluid before each open-end filter assemblies 124 and 130. The additional pressure gauges may allow fluid processing system 106 to further control the pressures within open-end filter assemblies 124 and 130.

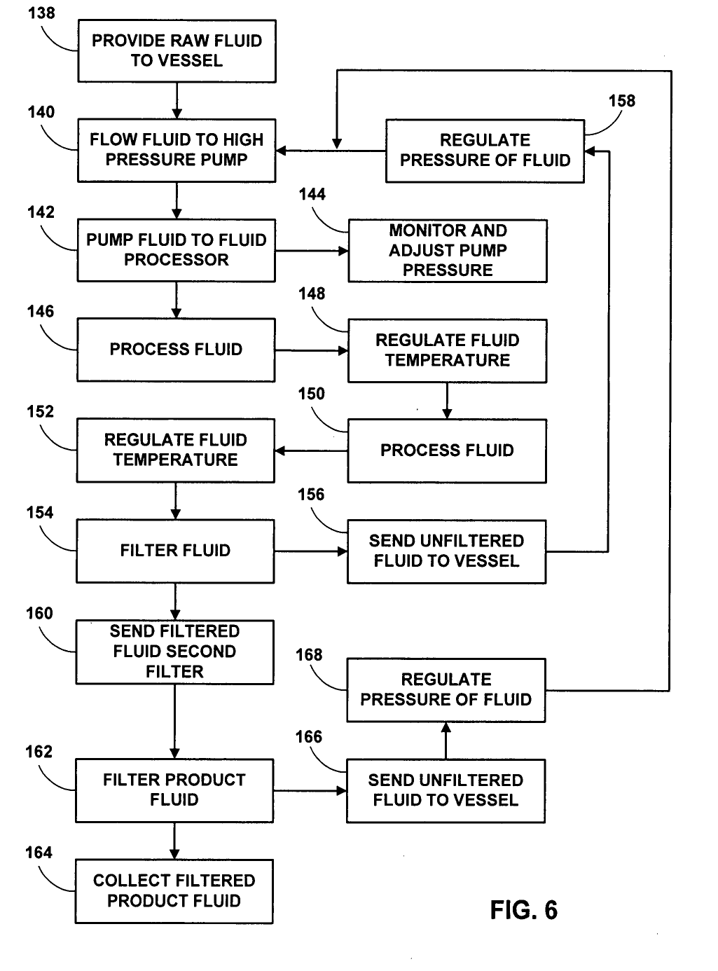

FIG. 6 is a flow diagram of an example method for operating fluid processing system 106 of FIG. 5. The processing raw fluid 108 begins with providing the raw fluid to vessel 110 by an automated delivery system or workers for fluid processing system 106 (138). From vessel 110, raw fluid 108 is directed to flow to pump 112 for pressurization (140). Pump 112 increases the pressure of raw fluid 108 and pumps the raw fluid to fluid processor 116 (142). Input pressure gauge 114 monitors the pressure of raw fluid 108 to determine if the pressure of the fluid is within a desired range and indicates to pump 116 if a change in pressure is needed (144). Raw fluid 108 is directed to fluid processor 116 where it is processed (146).

After raw fluid 58 is processed by fluid processor 116 (146), heat exchanger 118 regulates the temperature of the processed fluid (148). Then, fluid processor 120 further processes the fluid (150) before heat exchanger 122 regulates the temperature of the processed fluid (152). In some examples, temperature gauges may be utilized by heat exchangers 118 and 122 to regulate the temperature of the fluid. Next, the processed fluid is directed to open-end filter assembly 124 where the processed fluid is filtered and separated into two portions (154). The unfiltered portion of fluid is directed back to vessel 110 for reprocessing (156). Output pressure gauge 126 monitors the pressure of the unfiltered portion of fluid which is regulated by back pressure regulator 128 (158). The output flow rate of the unfiltered portion of fluid may also be regulated by back pressure regulator 128. The filtered portion is sent to open-end filter assembly 130 for further filtering (160).

Open-end filter assembly 130 filters the fluid again to separate particulates into predetermined size classes (162). Particulates and fluid allowed to pass through the filter element of open-end filter assembly 130 are collected as product fluid 132 to be used for an application (164). Particulates and fluid not filtered by open-end filter assembly 130 are sent back to vessel 110 for reprocessing (166). Output pressure gauge 134 monitors the pressure of the unfiltered portion of fluid which is regulated by back pressure regulator 136 before continuing in fluid processing system 106 (168). In addition, back pressure regulator 136 may regulate the output flow rate of the unfiltered portion of fluid. The recirculation of the second portion of fluid from open-end filter assemblies 124 and 130 allows fluid processing system 106 to maximize the amount of product fluid 132 while minimizing any waste particulates and fluid. Multiple open-end filter assemblies may allow system 106 to process a greater volume of raw fluid 108 in less time while retaining control over the size of particulates in the dispersed phases of product fluid 132.

Any of fluid processing systems 10, 56 and 106 may have alternative arrangements of some elements. For example, systems 10, 56 or 106 may include a low pressure heat exchanger immediately upstream of any pump in the system. This low pressure heat exchanger may regulate the temperature of the fluid before the fluid is subjected to higher pressures within the system. The fluid may be cooled or heated, depending upon the fluid or dispersed phases being processed. In addition, systems 10, 56 or 106 may include one or more high pressure heat exchangers immediately before, or combined with, any fluid processor within the system. A high pressure heat exchanger may be used to reduce the temperature of pressurized dispersed phases from a high pressure pump before being processed, for example. These low pressure and high pressure heat exchangers may be used in addition to or in place of any other heat exchangers in the system, in any combination.

Additionally, system 10, 56 or 106 may be controlled via an automated controller, i.e., a control system. The controller may be realized as any type of electronic or actuated system that uses feedback from pressure gauges, temperature sensors, flow meters, or any other devices that measure conditions within the respective fluid processing system. Example controllers may be a computer, a programmable logic controller (PLC), a PID program, or any other method of automated control commonly used in control systems. The computer may utilize an input/output board controlled by a processor that runs any type of software or firmware.

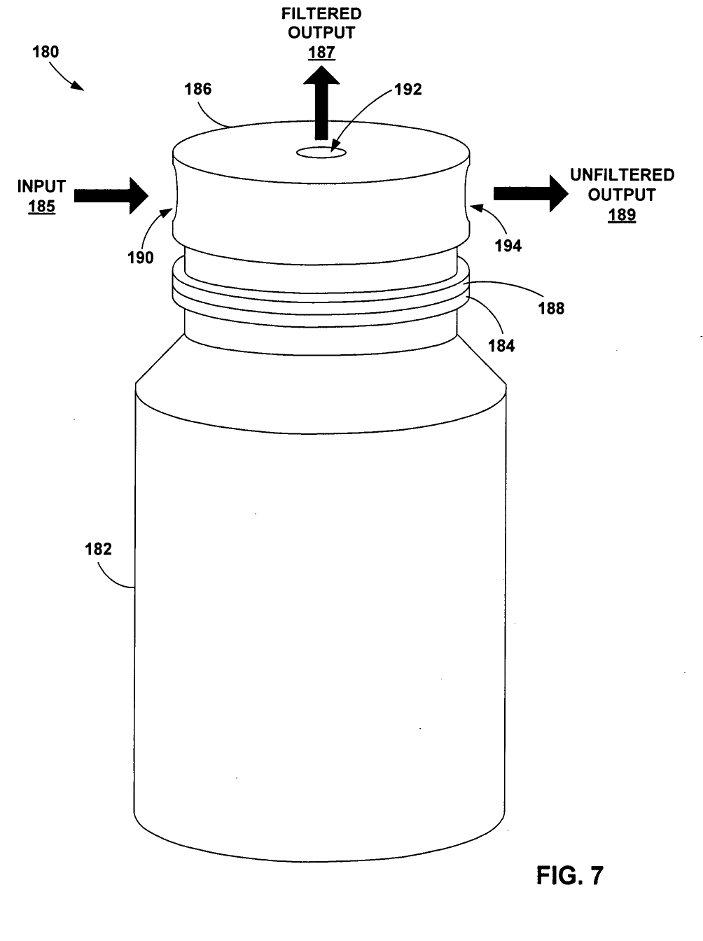

FIG. 7 is a perspective view of open-end filter assembly 180 including a filter head and an outer cylinder showing input and output directions. As shown in FIG. 7, open-end filter assembly 180 may be an embodiment of any one of open-end filter assemblies 24, 74, 124 and 130 described herein. However, open-end filter assembly 180 may be described generally according to open-end filter assembly 24 in fluid processing system 10 of FIG. 1, as an example. Open-end filter assembly 180 includes filter head 186 and outer cylinder 182. Filter head 186 allows input 185 to enter via inlet 190, filtered output 187 to leave open-end filter assembly 180 via filtered outlet 192, and unfiltered output 189 to leave the open-end filter assembly via bypass outlet 194. The arrows for each of input 185, filtered output 187 and unfiltered output 189 indicate the direction of fluid flow in relation to open-end filter assembly 180.

Outer cylinder 182 is substantially cylindrical with a closed in bottom. The only opening of outer cylinder is located at the top to accept a filter element (not shown in FIG. 7) and filter head 186. Outer cylinder also includes flange 184 which mates to flange 188 of filter head 186. A lockable collar (not shown in FIG. 7) is used to compress flanges 184 and 188 in order to seal filter head 186 to outer cylinder 182. In some examples, filter head 186 may connect to outer cylinder 182 with a helical thread of the filter head that mates to helical groves of the outer cylinder, or vice versa. In other examples, a twist lock, pins, screws, latches, or any other fixation device may be used to secure and seal filter head 186 to outer cylinder 182. Any fixation device or mechanism may need to support high pressures produced by pump 16.

Outer cylinder 182 may be constructed of any type of material that can withstand the stresses from internal fluid pressure and not react with the fluid being processed and filtered. Possible materials for outer cylinder 182 include aluminum, steel, stainless steel, titanium, a metal alloy or composites. In addition, polymers such as ultrahigh molecular weight polyurethane, delrin, nylon, or polycarbonate may be used to construct outer cylinder 182. In alterative examples, outer cylinder 182 may be constructed of more than one material to satisfy the design requirements of fluid processing system 10.

Outer cylinder 182 may be designed with any dimensions necessary to the particular purpose of fluid processing system 10. Generally, outer cylinder 182 may have an outer height between 5.0 centimeters (cm) and 30 cm. In one example, the outer height of outer cylinder 182 may be approximately 15.4 cm. The inner height of the outer flow channel defined by outer cylinder 182 may be between 4.5 cm and 29 cm. In one example, the inner height of outer cylinder is approximately 13.7 cm. The outer diameter of outer cylinder 182 may be generally between 5.0 cm and 20 cm, while an example outer diameter may be approximately 10.5 cm. The inner diameter of outer cylinder 182 may be generally between 3.0 cm and 19 cm, while an example inner diameter may be approximately 6.7 cm. The dimensions described herein are provided for exemplary purposes, and other dimensions are contemplated.

Filter head 186 is cylindrically shaped to match the shape of outer cylinder 182. However, filter head 186 may be any shape as long as the filter head is configured to mate to outer cylinder 182. Filter head 186 defines inlet 190, filtered outlet 192 and bypass outlet 194, which are the only passages for fluid in or out of open-end filter assembly 180. Inlet 190 accepts input 185 that is the processed fluid in system 10. Filtered outlet 192 accepts filtered output 187 that is product fluid 26 of system 10. Bypass outlet 194 accepts unfiltered output 189 that is the second portion of the processed fluid that is re-circulated within fluid processing system 10. While inlet 190 and bypass outlet 194 are located on the sides of filter head 186 and filtered outlet 192 is located in the top surface of the filter head, inlet 190 and outlets 192 and 194 may be located in any combination of side and top surface of the filter head that is necessary to the design of fluid processing system 10.

Filter head 186 may be constructed of any type of material that can withstand the stresses from internal fluid pressure and not react with the fluid being processed and filtered. Possible materials for filter head 186 may include polymers such as ultrahigh molecular weight polyurethane, delrin, nylon, or polycarbonate. In addition, other materials may include aluminum, steel, stainless steel, titanium, a metal alloy, composites, or any other material that may be tooled according to the description herein. In one example, filter head 186 may be constructed of a single block of material that is shaped according to the needed dimensions and drilled to include inlet 190 and outlets 192 and 194. In alterative examples, filter head 186 may be constructed of more than one material to satisfy the design requirements of fluid processing system 10.

Filter head 186 may be designed with any dimensions necessary to the particular purpose of fluid processing system 10. Generally, filter head 186 may have an outer diameter between 5 cm and 20 cm. In one example, the outer diameter of filter head 186 may be approximately 9.2 cm. The outer height of filter head 186, from flange 188 to the top surface may be generally between 2.0 cm and 10 cm. In one example, the outer height may be approximately 4.3 cm. The total height of filter head 186, from within outer cylinder 182 to the top surface of the filter head, may be generally between 2.0 cm and 12 cm. In one example, the total height may be approximately 5.3 cm. Inlet 190 and outlets 192 and 194 may have a diameter between 0.5 cm and 4 cm. In one example, the diameter of inlet 190 and outlets 192 and 194 is approximately 1.6 cm. The dimensions described herein are provided for exemplary purposes, and other dimensions are contemplated.

While open-end filter assembly 180 is described to be generally cylindrical in shape, the open-end filter assembly may be constructed of any shape. In some examples, open-end filter assembly 180 may be spherical, cuboidal, rectangular, asymmetrical, pyramidal, cone shaped, or any other desired shape. In addition, while outer cylinder 182 is generally formed to accept the entire filter element (not shown), the outer cylinder may be formed to cover a portion of the filter element while filter head 186 covers the rest of the filter element. Alternatively, inlet 190 and/or outlet 194 may be formed within outer cylinder 182.

In some examples, open-end filter assembly 180 may be constructed as an encapsulated disposable element of fluid processing system 10. Outer cylinder 182 may be adhered to filter head 186 with the filter element located inside. The user may simply attach the tubes or pipes to inlet 190 and outlets 192 and 194. When the filter element either needs to be replaced or is no longer needed, the user may discard the entire open-end filter assembly 180. Alternatively, filter head 186 may be attached to the filter element and a liner that isolates outer cylinder 182 from the fluid. In this case, the user may remove the disposable filter head package when necessary without exposing the user to particulates and fluid in the filter element. In either case, open-end filter assembly 180 may be constructed in a disposable fashion as desired by the user.

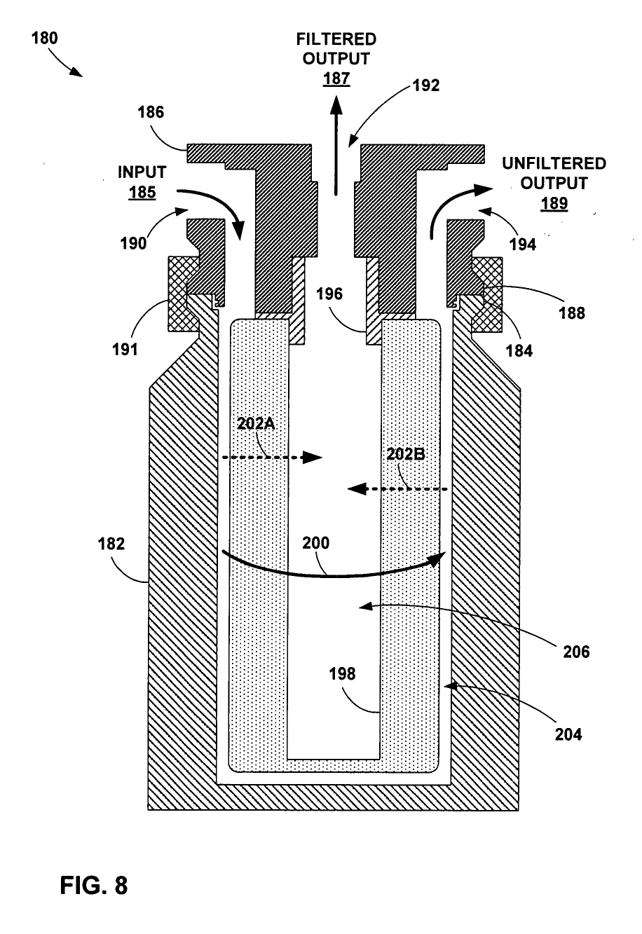

FIG. 8 is a cross-sectional side view of open-end filter assembly 180 of FIG. 7. As shown in FIG. 8, filter head 186 is coupled to filter element 198 via connection member 196. Filter head 186 is sealed to outer cylinder 182 by lockable collar 191 contacting flanges 184 and 188. In this assembled view of open-end filter assembly 180, input 185 enters the open-end filter through inlet 190 of an outer region of filter head 186 and flows into outer flow channel 204 defined by the inner wall of outer cylinder 182 and the outer surface of filter element 198. The fluid flows around cylindrical filter element 198 in the direction of arrow 200 toward bypass outlet 194. As the fluid is within outer flow channel 204, a portion of the fluid and particulates will be able to pass through filter element 198 in the direction of arrows 202A and 202B.

The pressure within outer flow channel 204 is greater than the pressure within inner flow channel 206, which drives the flow of a portion of fluid and particulates through filter element 198. The dispersed phases, e.g., fluid and particulates, allowed through filter element 198 is then located within inner flow channel 206. These dispersed phases pass out of filtered outlet 192 of a center region of filter head 186 as filtered output 187, or product fluid 26 of fluid processing system 10. The portion of fluid and particulates that does not pass through filter element 198 exits outer flow channel 204 via bypass outlet 194 of the outer region of filter head 186 as unfiltered output 189. Unfiltered output 189 is sent back through fluid processing system 10 to reprocess the unfiltered output fluid and reduce the amount of waste product from the system.

Arrow 200 indicates the general direction of fluid flow around filter element 198 and does not necessarily indicate any circular flow around the circumference of filter element 198. Generally, the fluid surrounds the entire surface of filter element 198 as it flows over the filter element on its way toward bypass outlet 194. In some examples, structures may be formed on the inner wall of outer cylinder 182 in order to create desired flow patterns or reduce stagnation points in contrast to possible flow characteristics of entirely smooth surface of the inner wall of the outer cylinder.

Filter head 186 may include helical grooves around each of inlet 190 and outlets 192 and 194 to accept threaded tubes or pipes which carry the fluid to and away from open-end filter assembly 180. Connection member 196 is coupled to filter head 186 and filter element 198 via a friction fit. In other examples, connection member 196 may include other fixation techniques to keep filter element 198 connected to filter head 186. An o-ring may be provided between connection member 196 and filter head 186 and also between filter head 186 and outer cylinder 182 to create a fluid tight seal.

Filter element 198 of open-end filter assembly 180 may be a filter cartridge conventionally used within fluid processing systems currently used to separate dispersed phases. Filter element 198 may not necessarily include dimensions as shown in FIG. 8. For example, filter element 198 may be constructed of a polymer film, a wound filament, a porous mesh, or any other type of filter element suited for filtering the size of particulates of filtered output 187. Alternatively, filter element 198 may filter the dispersed phases according to a property other than particulate size. For example, filter element 198 may allow particulates to pass according to their electrical charge, hydrophobic/hydrophilic characteristics, buoyancy, or any other property that can be used to separate particulates within the fluid.

Open-end filter assembly 180 may be configured such that filter element 198 is removable from the open-end filter assembly. A user may remove lockable collar 192 to separate filter head 186 from outer cylinder 182. The user may then remove the used filter element 198 from connection member 196 and subsequently add a new filter element 198 to the connection member before reattaching filter head 186 to outer cylinder 182. The new filter element may be placed within open-end filter assembly 180 to continue filtering the processed fluid.

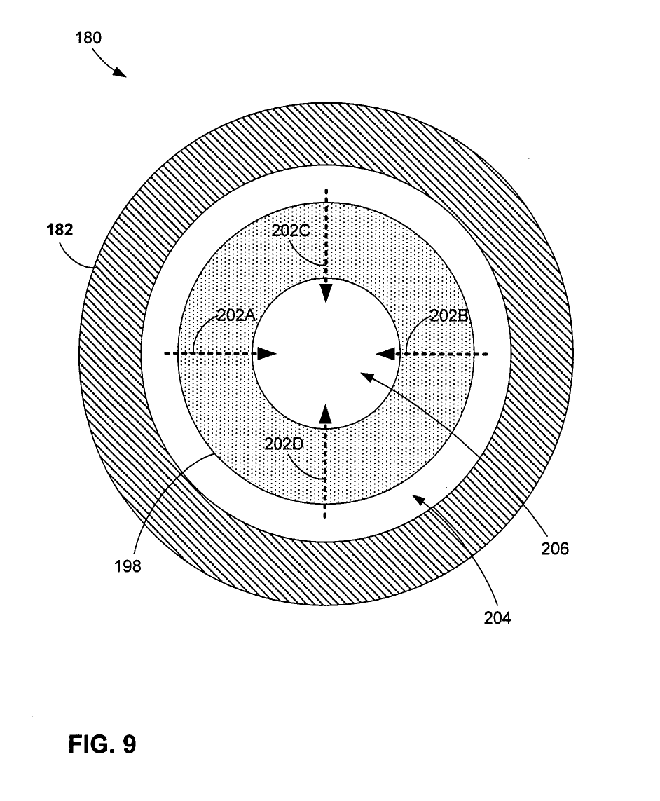

FIG. 9 is a cross-sectional axial view of the open-end filter assembly of FIG. 7. As shown in FIG. 9, open-end filter assembly 180 includes outer cylinder 182 and filter element 198 which define outer flow channel 204 and inner flow channel 206. Outer flow channel 204 also shares a central axis with inner flow channel 206. Fluid is added to outer flow channel 204 under pressure which generates a pressure gradient across filter element 198. The greater pressure within outer flow channel 204 forces fluid and particulates capable of passing though filter element 198 into inner flow channel 206, which is at a lesser pressure. The transfer of fluid and particulates from outer flow channel 204 to inner flow channel 206 is a function of the permeability of filter element 198 and the pressure gradient from the outer flow channel to the inner flow channel.

Arrows 202A, 202B, 202C and 202D (collectively “arrows 202”) indicate the direction of fluid flow from outer channel 204 towards inner flow channel 206. Arrows 202 show that fluid may generally pass through filter element 198 in a uniform manner. However, in practice, passage of fluid at some locations of filter element 198 may be greater than at other locations of the filter element. Over time, some particulates may become lodged within filter element 198 and necessitate the replacement of the filter element to continue effective filtration.

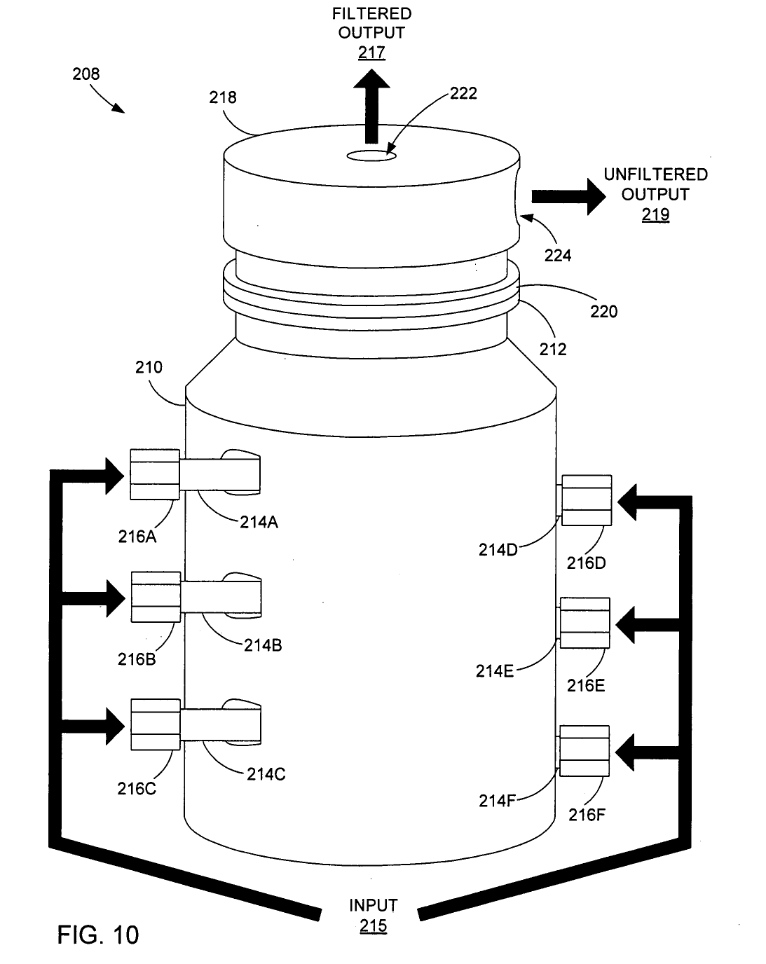

FIG. 10 is a perspective view of open-end filter assembly 208 that inputs the fluid through tangential channels oriented tangentially to the outer flow channel of the filter assembly. Open-end filter assembly 208 may be substantially similar to open end filter assembly 180 of FIG. 7. However, open-end filter assembly 208 creates circulation in the outer flow channel within outer cylinder 210. As shown in FIG. 10, open-end filter assembly 208 may be an embodiment of any one of open-end filter assemblies 24, 74, 124 and 130 described herein. However, open-end filter assembly 208 may be described generally according to open-end filter assembly 24 in fluid processing system 10 of FIG. 1 as an example similar to FIG. 7.

Open-end filter assembly 208 includes filter head 218 and outer cylinder 210. Outer cylinder 210 allows input 215 to enter outer cylinder 210 via inlets 214A, 214B, 214C, 214D, 214E and 214F (collectively “inlets 214”). Filter head 218 allows filtered output 217 to leave open-end filter assembly 208 via filtered outlet 222 and unfiltered output 219 to leave the open-end filter assembly via bypass outlet 224. The arrows for each of input 215, filtered output 217 and unfiltered output 219 indicate the direction of fluid flow in relation to open-end filter assembly 218.

Outer cylinder 210 is substantially cylindrical with a closed in bottom. Outer cylinder includes flange 212 which mates to flange 220 of filter head 218. A lockable collar (not shown in FIG. 10) is used to compress flanges 212 and 220 in order to seal filter head 218 to outer cylinder 210. In some examples, filter head 218 may connect to outer cylinder 210 with a helical thread of the filter head that mates to helical groves of the outer cylinder, or vice versa. In other examples, a twist lock, pins, screws, latches, or any other fixation device may be used to secure and seal filter head 218 to outer cylinder 210. Any fixation device or mechanism may need to support high pressures produced by pump 16.

Input 215 is delivered to the outer flow channel (not shown) via inlets 214. Each inlet 214 is a tangential channel that resides through the wall of outer cylinder 210. Inlets 214 are oriented tangentially with respect to the outer flow channel within outer cylinder 210 at two circumferential locations around the outer flow channel and the outer cylinder. Three inlets 214 are located on opposing sides of outer cylinder 210, and other examples may include any number of inlets at any number of circumferential locations around the outer flow channel. In this manner, the pressure of input 215 fluid creates circulating flow within the outer flow channel around the filter element (not shown) of open-end filter assembly 208. The circulating flow may reduce particulate build-up on the outside of the filter element to improve filtering efficiency and increase the usable life of the filter element.

Each inlet 214 includes a cylindrical tube extending from the outer surface of outer cylinder 210. In addition, connection nuts 216A, 216B, 216C, 216D, 216E and 216F (collectively “nuts 216”) are attached to each respective inlet 214. Nuts 216 may include helical grooves to accept a threaded end of a tube or pipe that delivers the processed fluid which is input 215. A user may use a wrench to rotate each of nuts 216 to secure the pipes to inlets 214. In other examples, lure locks, welding, latches, or any other locking mechanism may be used instead of nuts 216 to secure the pipes which deliver input 215 to inlets 214.

Each location of inlets 214 may be staggered around outer cylinder 210. Generally, each inlet may be equally spaced in height with other inlets at the same circumferential location. In one example, inlets 214A, 214B and 214C may be located at heights of 11.5 cm, 7.6 cm and 3.7 cm, respectively along an outer cylinder 210 of 15.4 cm in height. Additionally, inlets 214D, 214E and 214F may be located at heights of 9.5 cm, 5.6 cm and 1.7 cm, respectively. While the heights of inlets 214A, 214B and 214C are not equal to the heights of 214D, 214E and 214F, respectively, inlets at equal heights may be utilized. In addition to heights of inlets 214, circumferential locations of the inlets may be equally spaced around outer cylinder 210.

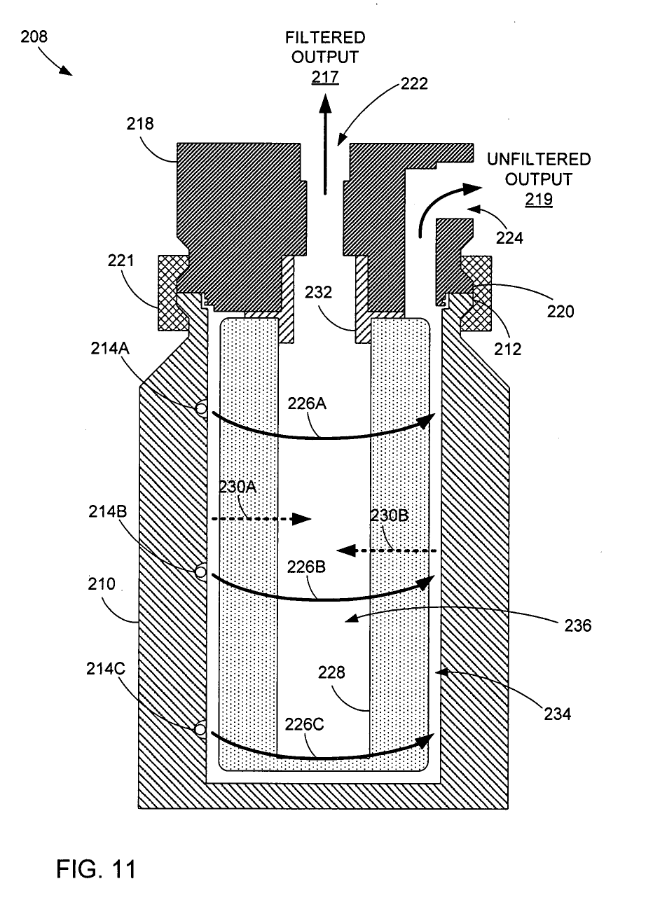

FIG. 11 is a cross-sectional side view of open-end filter assembly 208 of FIG. 10. As shown in FIG. 11, filter head 218 is coupled to filter element 228 via connection member 232. Filter head 218 is sealed to outer cylinder 210 by lockable collar 221 contacting flanges 212 and 220. In this assembled view of open-end filter assembly 208, input 215 enters the open-end filter assembly through inlets 214A, 214B and 214C (inlets 214D, 214E, and 214F are not shown) and flows into outer flow channel 234 defined by the inner wall of outer cylinder 210 and the outer surface of filter element 228. The fluid flows in a circular manner around cylindrical filter element 228 within outer flow channel 234 in the direction of arrows 226A, 226B and 226C (collectively “arrows 226”). A general upward flow of fluid within outer flow channel 234 also occurs toward bypass outlet 224. As the fluid is within outer flow channel 234, a portion of the fluid and particulates will be able to pass through filter element 228 in the direction of arrows 230A and 230B.

The pressure within outer flow channel 234 is greater than the pressure within inner flow channel 236, which drives the flow of a portion of fluid and particulates through filter element 228. The dispersed phases, e.g., fluid and particulates, allowed through filter element 228 is then located within inner flow channel 236. These dispersed phases pass out of filtered outlet 222 of a center region of filter head 218 as filtered output 217, or product fluid 26 of fluid processing system 10. The portion of fluid and particulates that does not pass through filter element 228 exits outer flow channel 234 via bypass outlet 224 of an outer region of filter head 218 as unfiltered output 219. Unfiltered output 219 is sent back through fluid processing system 10 to reprocess the unfiltered output fluid and reduce the amount of waste product from the system.

Arrows 226 indicate the direction of the circular flow generated from the tangential orientation of inlets 214. The circular flow around filter element 228 may expose a greater volume of fluid and particulates to the filter element while reducing the amount of accumulation of particulates to the outside of the filter element. In this manner, filter element 228 may be used to filter a greater volume of dispersed phases without needing to be replaced. The circular flow within outer flow channel 234 may also have an upward flow toward the lower pressure at bypass outlet 224. This upward flow brings dispersed phases not passing though filter element 228 out of open-end filter assembly 218 as unfiltered output 219 and directed back into fluid processing system 10. In some examples, structures may be formed on the inner wall of outer cylinder 210 in order to create desired flow patterns or reduce stagnation points in contrast to possible flow characteristics of entirely smooth surface of the inner wall of the outer cylinder.

Filter head 218 may include helical grooves around each of outlets 222 and 224 to accept threaded tubes or pipes which carry the fluid to and away from open-end filter assembly 208. Connection member 232 is coupled to filter head 218 and filter element 228 via a friction fit. In other examples, connection member 232 may include other fixation techniques to keep filter element 228 connected to filter head 218. An o-ring may be provided between connection member 232 and filter head 218 and also between filter head 218 and outer cylinder 210 to create a fluid tight seal.

Filter element 228 of open-end filter assembly 208 may be a filter cartridge conventionally used within fluid processing systems currently used to separate dispersed phases. Filter element 228 may not necessarily include dimensions as shown in FIG. 11. For example, filter element 228 may be constructed of a polymer film, a wound filament, a porous mesh, or any other type of filter element suited for filtering the size of particulates of filtered output 217. Filter element 228 may have a smooth outer surface or structured outer surface to trap particulates and/or create turbulence within outer flow channel 234. Alternatively, filter element 228 may filter the dispersed phases according to a property other than particulate size. For example, filter element 228 may allow particulates to pass according to their electrical charge, hydrophobic/hydrophilic characteristics, buoyancy, or any other property that can be used to separate particulates within the fluid.

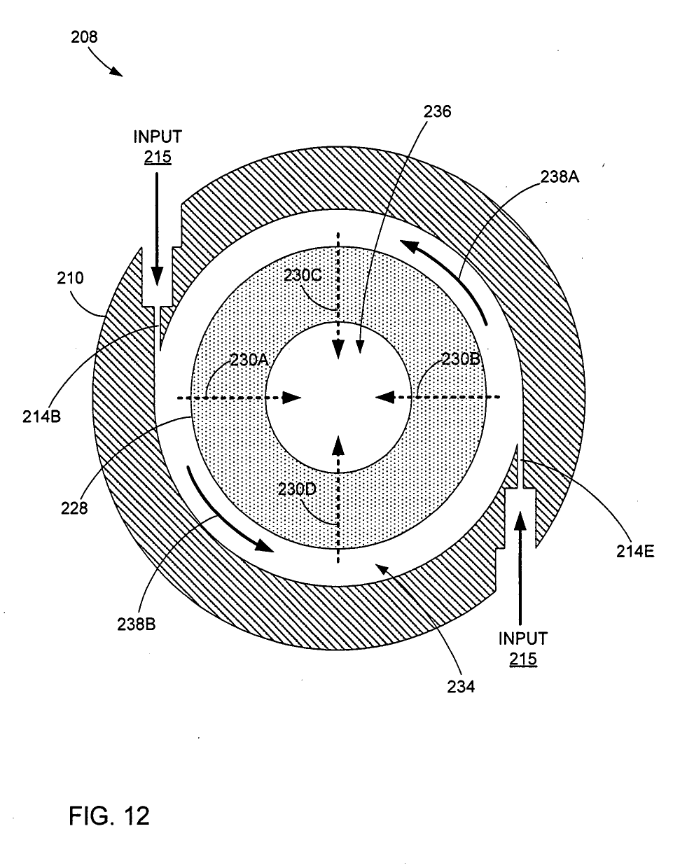

FIG. 12 is a cross-sectional axial view of open-end filter assembly 208 of FIG. 10 illustrating circular flow within the outer flow channel. As shown in FIG. 12, open-end filter assembly 208 includes outer cylinder 210 and filter element 228 which define outer flow channel 234 and inner flow channel 236. Outer flow channel 234 also shares a central axis with inner flow channel 236. Fluid, input 215, is added to outer flow channel 234 under pressure via inlets 214B and 214E. The tangentially oriented channels of inlets 214 create circulation within outer flow channel 234 in the direction of arrows 238A and 238B. Fluid velocity in the direction of arrows 238 may remain constant with constant pressure. The fluid velocity may be a function of the dispersed phases properties and pressure gradient between outer flow channel 234 and inner flow channel 236.

The pressure of input 215 generates a pressure gradient across filter element 228. The greater pressure within outer flow channel 234 forces fluid and particulates capable of passing though filter element 228 into inner flow channel 236, which is at a lesser pressure. The transfer of fluid and particulates from outer flow channel 234 to inner flow channel 236 is a function of the permeability of filter element 228, the pressure gradient from the outer flow channel to the inner flow channel, and possibly the velocity of fluid in the direction of arrows 238.

Arrows 230A, 230B, 230C and 230D (collectively “arrows 230”) indicate the direction of fluid flow from outer channel 234 towards inner flow channel 236. Arrows 230 show that fluid may generally pass through filter element 228 in a uniform manner. However, passage of fluid at some locations of filter element 228 may be greater than at other locations of the filter element. Over time, some particulates may become lodged within filter element 228 and necessitate the replacement of the filter element to continue effective filtration. In some examples, more or less inlets 214 may be provided around the circumference of outer flow channel 234 to produce the circular flow within the outer flow channel.

Many embodiments of the disclosure have been described. Various modifications may be made without departing from the scope of the claims. For example, although the invention has been described in terms of application to industrial manufacturing of coatings, inks, paints, abrasive coatings, fertilizers, foods, beverages, pharmaceuticals, biological products, thickening agents, and agricultural products, the invention may be applicable to a combination of any of a variety of fluids and/or materials to form dispersions, emulsions, suspensions, solutions, or the like. In addition, the invention may be applicable to a combination of two or more fluids having different compositions or substantially identical compositions. These and other embodiments are within the scope of the following claims.

1. An open-end filter assembly comprising:
an inlet;
a bypass outlet;
an outer flow channel coupled to the inlet and the bypass outlet;
an inner flow channel in fluid communication with the outer flow channel via the filter element; and
a filtered outlet coupled to the inner flow channel.

2. The open-end filter assembly of claim 1, wherein the filter element is cylindrical, and wherein the outer flow channel and inner flow channel share a central axis.

3. The open-end filter assembly of claim 1, wherein the inlet and bypass outlet are housed within an outer region of a filter head and the filtered outlet is housed within a center region of the filter head.

4. The open-end filter assembly of claim 1, wherein the inner flow channel is defined by the filter element, and wherein the outer flow channel is defined by an outer cylinder and the filter element.

5. The open-end filter assembly of claim 4, wherein the inlet comprises one or more tangential channels formed within the outer cylinder and oriented tangentially to the outer flow channel.

6. The open-end filter assembly of claim 1, further comprising:
a connection member that couples the filter element to a filter head, wherein the filter element is configured to fit within an outer cylinder and the filter head is configured to mate with the outer cylinder; and
a lockable collar configured to mate with a filter head flange and an outer cylinder flange and seal the filter head to the outer cylinder.

7. The open-end filter assembly of claim 1, wherein the open-end filter is constructed as an encapsulated disposable element.

8. A system comprising:
a fluid pump;
a fluid processor that processes raw fluid from the fluid pump; and
an open-end filter assembly that allows a first portion of the fluid to pass through a filter element of the open-end filter assembly and directs a second portion of the fluid to the fluid pump.

9. The system of claim 8, further comprising a heat exchanger that at least one of heats and cools the fluid before the fluid enters the open-end filter assembly.

10. The system of claim 9, wherein the heat exchanger is at least one of a high pressure heat exchanger downstream of a high pressure pump and upstream of the fluid processor and a low pressure heat exchanger downstream of the fluid processor and upstream of the open-end filter assembly.

11. The system of claim 8, further comprising:
at least one of an input pressure gauge that measures fluid pressure from the fluid pump, an output pressure gauge that measures fluid pressure of the second portion of the fluid, a flow meter that measures a flow rate of the first portion of the fluid, and a flow meter that measures a flow rate of the second portion of the fluid; and
a back pressure regulator that regulates fluid pressure of the second portion of the fluid from the open-end filter assembly.

12. The system of claim 8, wherein the fluid processor is an annular flow processor comprising a first annular flow channel that meets a second annular flow channel opposing the first annular flow channel at an outlet of the fluid processor.

13. The system of claim 8, wherein the open-end filter assembly comprises:
an inlet;
a bypass outlet;
an outer flow channel coupled to the inlet and the bypass outlet;
an inner flow channel in fluid communication with the outer flow channel via the filter element; and
a filtered outlet coupled to the inner flow channel.

14. The system of claim 13, wherein:
the outer flow channel is defined by an outer cylinder and the filter element; and
the inlet comprises one or more tangential channels formed through the outer cylinder and oriented tangentially to the outer flow channel.

15. The system of claim 8, wherein the open-end filter assembly comprises a primary open-end filter assembly, the system further comprising a secondary open-end filter assembly arranged in series with the primary open-end filter assembly, wherein the primary open-end filter assembly directs the first portion of fluid to the secondary open-end filter assembly.

16. The system of claim 8, further comprising a valve capable of being configured to prevent the second portion of fluid from flowing through the bypass outlet.

17. A method comprising:
pumping a fluid to a fluid processor with a fluid pump;
processing the fluid with the fluid processor;
directing the fluid into an inlet of an open-end filter assembly;
directing the fluid through an outer flow channel coupled to the inlet of the open-end filter assembly and a bypass outlet of the open-end filter assembly;
passing a first portion of the fluid through a filter element of the open-end filter assembly;
directing the first portion of the fluid through a filtered outlet of the open-end filter assembly; and
directing a second portion of the fluid through the bypass outlet of the open-end filter assembly and to the fluid pump.

18. The method of claim 17, further comprising controlling the temperature of the fluid before directing the fluid to the open-end filter assembly.

19. The method of claim 17, further comprising:
measuring at least one of an input pressure and an input flow rate of the fluid from the fluid pump;
measuring at least one of an output pressure and an output flow rate of the second portion of the fluid; and
regulating at least one of the output pressure and the output flow rate according to the measured output pressure.

20. The method of claim 17, wherein passing the first portion of the fluid further comprises allowing the first portion of the fluid to pass through the filter element of the open-end filter assembly and into an inner flow channel coupled to the filtered outlet.

21. The method of claim 17, wherein directing the fluid into the open-end filter assembly further comprises injecting the fluid through one or more tangential channels oriented tangentially to the outer flow channel and into the outer flow channel to create circular flow of the fluid within the outer flow channel.

22. The method of claim 17, wherein the open-end filter assembly comprises a primary open-end filter assembly, further comprising:
directing the first portion of the fluid to a secondary open-end filter assembly;
directing the first portion of the fluid through an outer flow channel of the secondary open-end filter assembly coupled to an inlet of the secondary open-end filter assembly and a bypass outlet of the secondary open-end filter assembly;
passing a third portion of the fluid through a filter element of the secondary open-end filter assembly;
directing the third portion of the fluid through a filtered outlet of the secondary open-end filter assembly; and
directing a fourth portion of the fluid through the bypass outlet of the secondary open-end filter assembly and to the fluid pump.

23. The method of claim 17, further comprising preventing the second portion of fluid from flowing through the bypass outlet.
